(19) United States
(12) Patent Application Publication
(10) Pub. No.: US 2014/0326606 A1
(43) Pub. Date: Nov. 6, 2014

(54) Method for Marking a Tool

(71) Applicant: Da-Sen LIN, Taichung City (TW)

(72) Inventor: Da-Sen LIN, Taichung City (TW)

(21) Appl. No.: 13/887,553

(22) Filed: May 6, 2013

(51) Int. Cl. B23H 9/06

(52) U.S. Cl. CPC B23H 9/06
USPC 205/52

(57) ABSTRACT

A method is disclosed for marking a tool. The method includes the steps of providing a tool, providing a rustproof layer on the tool, providing a printed layer on the tool, and providing at least one electroplated layer on the tool. The step of providing the rustproof layer includes the step of electroplating or hot-dip galvanizing the tool. The thickness of the electroplated layer is larger than or identical to that of the colored layer.

### BACKGROUND OF INVENTION

1. Field of Invention

The present invention relates to tools and, more particularly, to a method for marking tools.

2. Related Prior Art

People drive threaded bolts and nuts of various shapes and sizes with tools such as open-ended wrenches, box-ended wrenches, monkey wrenches, socket wrenches or screwdrivers. A toolkit may include a handle and a set of sockets and/or screwdriver bits of various shapes and sizes. In operation, the handle is connected to a selected one of the sockets and/or screwdriver bits for driving a threaded bolt or nut of a certain shape and size. Thus, a toolkit can be used to drive threaded bolts and nuts of various shapes and sizes. It is important to mark the tools to indicate their sizes and/or carry trademarks, logos and/or patterns.

Conventionally, a mark is provided on a tool by relief or provided in a tool by intaglio before the tool is electroplated. The mark and the background are substantially of a same color. The mark is not clearly visible amid the background as they are in weak contrast to each other.

Alternatively, a tool is electroplated before it is printed with a mark. The mark is clearly visible amid the background since they are in strong contrast to each other. However, the mark could easily be removed from the tool because of hits, abrasion or scratches. Hence, the clear visibility of the mark amid the background is not durable.

Disclosed in U.S. Pat. No. 7,448,121 issued to the present applicant is a method for marking a tool. In the method, a reverse-type mark is defined amid a painted layer on a tool. The painted layer is used as a background around the reverse-type mark. The painted layer includes paint of a color or paint of colors based on chromatography. Then, the tool is electroplated so that an electroplated layer covers the tool except the painted layer. The thickness of the painted layer is smaller than that of the electroplated layer so that the painted layer would not easily be removed from the tool by hits, abrasion or scratches and that the reverse-type mark could remain clearly visible amid the painted layer.

However, there is not unusual for rust to occur on the tool before the painted layer is provided on the tool. The rust affects the attachment of the painted layer to the tool. In that case, the painted layer could easily be removed from the tool. Therefore, the reverse-type mark would not be clearly visible amid the broken painted layer.

Therefore, the present invention is intended to obviate or at least alleviate the problems encountered in prior art.

### SUMMARY OF INVENTION

It is the primary objective of the present invention to provide an effective method for marking a tool.

To achieve the foregoing objective, the method includes the steps of providing a tool, providing a first electroplated layer on the tool, providing a printed layer on the tool, and providing a second electroplated layer on the tool.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a block diagram of an effective method for marking a tool according to the preferred embodiment of the present invention;

FIG. 2 is a perspective view of a tool at a first step of the method shown in FIG. 1;

FIG. 3 is a perspective view of the tool at a second step of the method shown in FIG. 1;

FIG. 4 is a perspective view of the tool at a third step of the method shown in FIG. 1;

FIG. 5 is a cross-sectional view of the tool shown in FIG. 4;

FIG. 6 is a perspective view of a tool at a fourth step of the method shown in FIG. 1; and

FIG. 7 is a cross-sectional view of the tool shown in FIG. 6.

### DETAILED DESCRIPTION OF PREFERRED EMBODIMENT

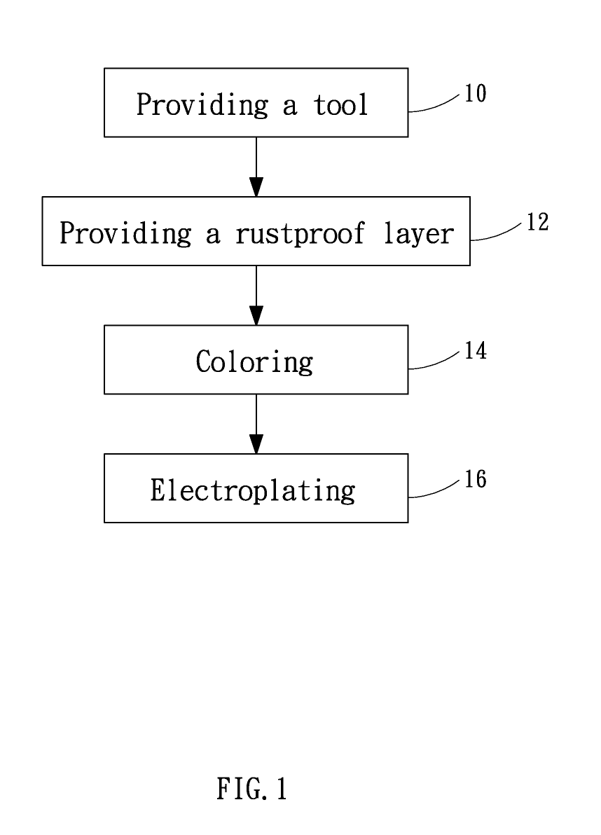

Referring to FIG. 1, there is an effective method for marking a tool according to the preferred embodiment of the present invention.

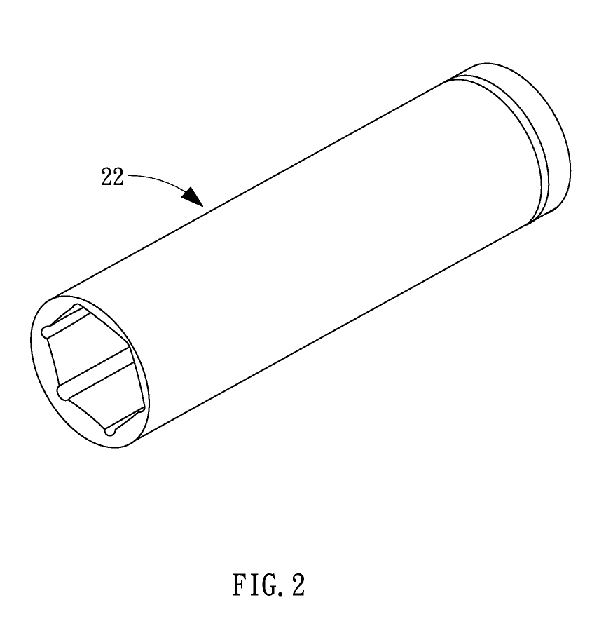

Referring to FIGS. 1 and 2, at 10, there is provided a tool 22. The tool 22 is a socket for example. The tool 22 is made by casting or forging. It is not unusual that the tool 22 carries static charges that attract dust.

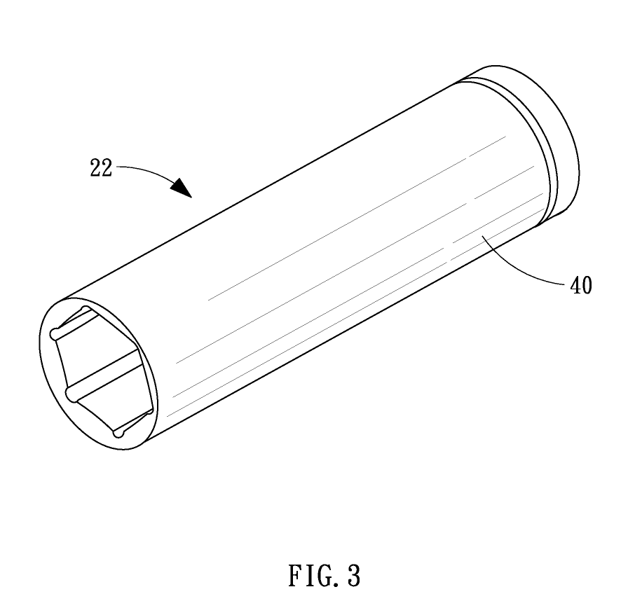

Referring to FIGS. 1 and 3, at 12, the tool 22 is provided with a rustproof layer 40. The rustproof layer 40 keeps the tool 22 from water, moisture, oxygen, acid or any other oxidizing material. The step of providing the rustproof layer 40 includes the step of electroplating or hot-dip galvanizing the tool 22 for example. The rustproof layer 40 includes chromium where the step of providing the rustproof layer 40 includes the step of electroplating the tool 22. Alternatively, the rustproof layer 40 includes zinc where the step of providing the rustproof layer 40 includes the step of hot-dip galvanizing the tool 22.

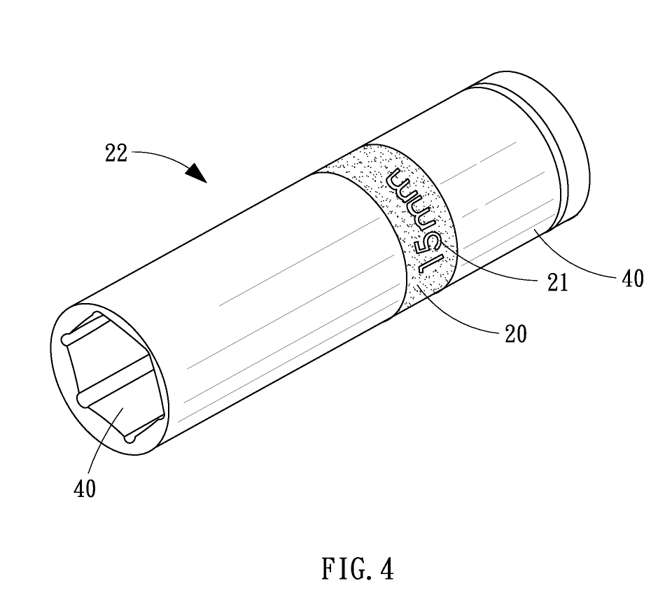

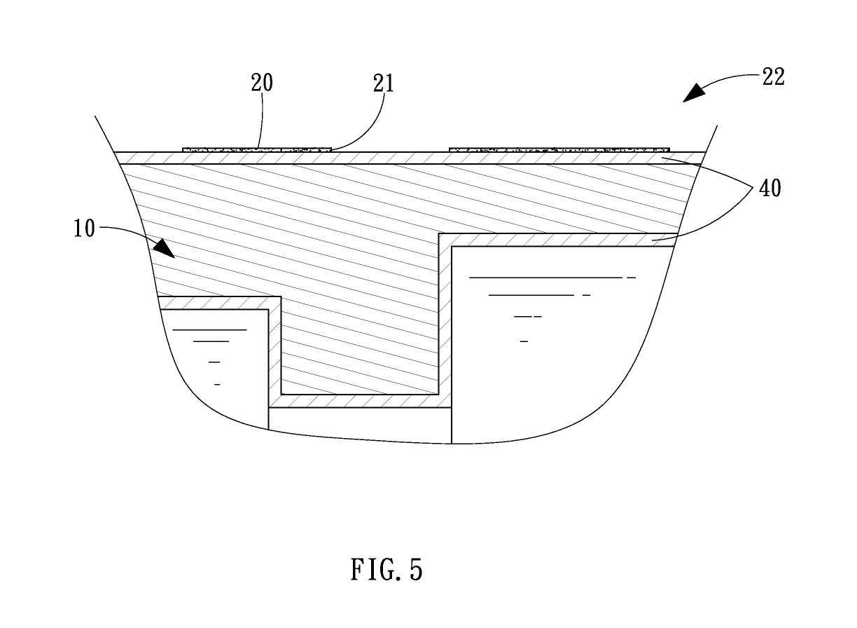

Referring to FIGS. 1, 4 and 5, at 14, the tool 22 is provided with a colored layer 20. The provision of the colored layer 20 may be done by dying, painting or printing for example. Preferably, a reverse-type mark 21 is defined amid the colored layer 20, which is used as a background in strong contrast to the reverse-type mark 21. However, in another embodiment, the colored layer 20 may be used as a mark. The colored layer 20 may include colorant of a single color or colorant of colors based on chromatography.

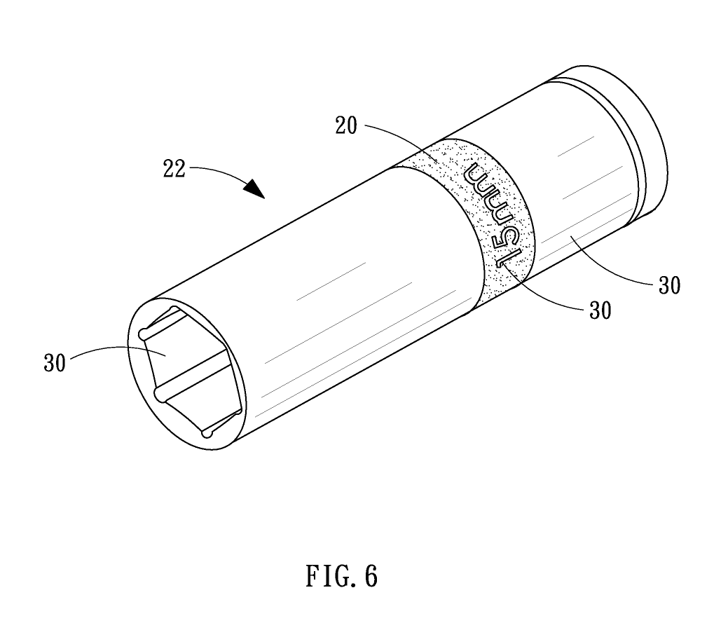

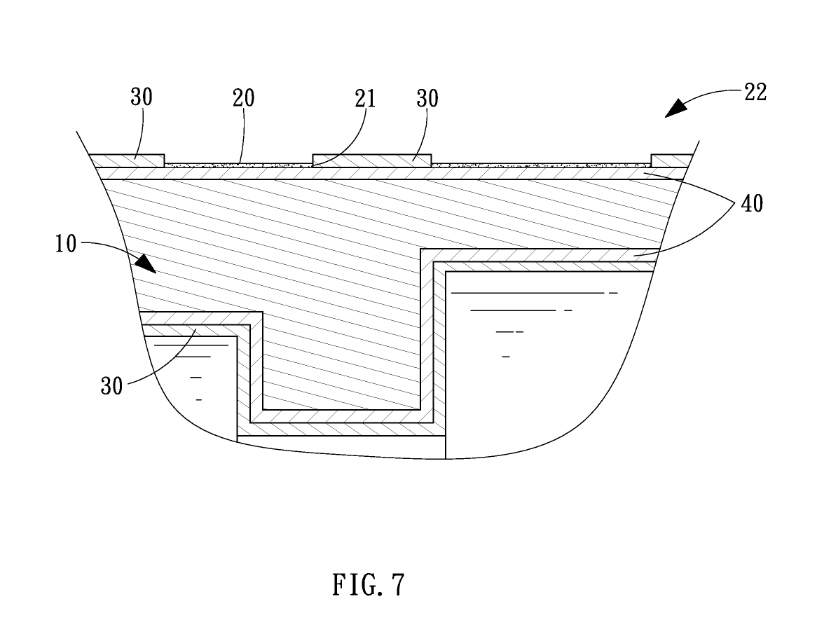

Referring to FIGS. 1, 6 and 7, at 16, the tool 22 is provided with another electroplated layer 30 that covers the rustproof layer 40, including the reverse-type mark 21. The electroplated layer 30 does not cover the colored layer 20 since the colored layer 20 is electrically isolating. Preferably, the thickness of the electroplated layer 30 is larger than that of the colored layer 20 so that the colored layer 20 would not easily be removed from the tool 22 by hits, abrasion or scratches. Therefore, the reverse-type mark 21 remains clearly visible amid the colored layer 20. However, the thickness of the electroplated layer 30 may be identical to that of the colored layer 20.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A method for marking a tool including the steps of providing a tool, providing a rustproof layer on the tool, providing a colored layer on the rustproof layer, and providing at least one electroplated layer on the rustproof layer.

2. The method according to claim 1, wherein the step of providing the rustproof layer includes the step of electroplating the tool.

3. The method according to claim 1, wherein the step of providing the rustproof layer includes the step of hot-dip galvanizing the tool.

4. The method according to claim 1, wherein the thickness of the electroplated layer is larger than that of the colored layer.

5. The method according to claim 1, wherein the thickness of the electroplated layer is identical to that of the colored layer.

6. The method according to claim 1, wherein the step of providing the colored layer includes the step of defining a reverse-type mark amid the colored layer, which is used as a background.

7. The method according to claim 1, wherein the colored layer includes colorant of a color.

8. The method according to claim 1, wherein the colored layer includes colorant of colors based on chromatography.

9. The method according to claim 1, wherein the step of providing the at least one electroplated layer includes the step of providing several electroplated layers.
